(19) United States
(12) Patent Application Publication
(10) Pub. No.: US 2025/0366452 A1
(43) Pub. Date: Dec. 4, 2025

(54) FISHING LINE GUIDE

(71) Applicant: Shimano Inc., Osaka (JP)

(72) Inventors: Kai SUZUKI, Osaka (JP); Kazuma TANIGUCHI, Osaka (JP); Yoshiyuki KAMINOU, Osaka (JP); Seita FUJIWARA, Osaka (JP); Tomoyuki KOZAWA, Osaka (JP)

(21) Appl. No.: 19/212,483

(22) Filed: May 19, 2025

(30) Foreign Application Priority Data
May 29, 2024 (JP) 2024-087000

(51) Int. Cl. A01K 87/04

(52) U.S. Cl. CPC A01K 87/04

(57) ABSTRACT

A fishing line guide mountable to a fishing rod body to guide a fishing line, the fishing line guide includes a foam portion made of foamed resin, and a reinforced resin portion made of fiber-reinforced resin and covering a part of the foam portion.

### CROSS-REFERENCE TO RELATED APPLICATIONS

This application claims priority to Japanese Patent Application No. 2024-087000, filed on May 29, 2024. The entire disclosure of Japanese Patent Application No. 2024-087000 is hereby incorporated by reference.

### BACKGROUND

### Technical Field

The present disclosure relates to a fishing line guide that guides a fishing line.

### Background Information

Fishing line guides that are attached to the outer circumferential surface of a rod body are generally required to be lightweight. Japanese Laid Open Patent Application No. 2011-205937 discloses a fishing line guide that includes prepreg.

### SUMMARY

It has been determined that there is a limit to how much weight can be reduced by forming a fishing line guide from prepreg. Accordingly, an object of the present disclosure is to provide a fishing line guide having reduced weight.

A fishing line guide according to one aspect of the present disclosure is attached to a fishing rod body and guides a fishing line. The fishing line guide comprises a foam portion and a reinforced resin portion. The foam portion includes foamed resin. The reinforced resin portion is made of fiber-reinforced resin. The reinforced resin portion covers a part of the foam portion.

According to this configuration, the fishing line guide comprises a foam portion. Therefore, it is possible to easily reduce the weight of the fishing line guide. In addition, the reinforced resin portion covers a part of the foam portion. Therefore, it is possible to protect the foam portion with the reinforced resin portion. Accordingly, it is possible to prevent damage to the fishing line guide while reducing the weight of the fishing line guide. In addition, since the foam portion can absorb impact, it is possible to make the reinforced resin portion thin and achieve both weight reduction and strength assurance.

A fishing line guide of a second aspect according to the first aspect of the present disclosure further comprises a guide ring and a guide frame. The guide ring guides the fishing line. The guide frame holds the guide ring. The guide frame is attached to the rod body. A part of the guide frame includes a foam portion and a reinforced resin portion. According to this configuration, since a part of the guide frame includes a foam portion and a reinforced resin portion, it is possible to reduce the weight of the guide frame and prevent damage to the guide frame.

In a fishing line guide of a third aspect according to the second aspect of the present disclosure, the guide frame comprises a mounting leg, a guide holder, and a support leg. The mounting leg is attached to the rod body. The guide holder holds the guide ring. The support leg connects the mounting leg and the guide holder. A part of the support leg includes a foam portion and a reinforced resin portion. According to this configuration, since a part of the support leg is formed of a foam portion and a reinforced resin portion, it is possible to reduce the weight of the support leg and prevent damage to the support leg.

In a fishing line guide of a fourth aspect according to the third aspect of the present disclosure, a leg tip of the support leg adjacent to the guide holder is formed of a foam portion and a reinforced resin portion. According to this configuration, since the leg tip of the support leg is formed of a foam portion and a reinforced resin portion, it is possible to easily reduce the weight of the support leg.

In a fishing line guide of a fifth aspect according to the third or fourth aspect of the present disclosure, a base part of the support leg adjacent to the mounting leg is formed only of a reinforced resin portion. According to this configuration, since the base part of the support leg is formed only of the reinforced resin portion, from among the foam portion and reinforced resin portion, it is possible to ensure the strength of the base part which is where a large force is likely to act.

In a fishing line guide of a sixth aspect according to any one of the second to the fifth aspects of the present disclosure, the guide frame comprises a mounting leg, a guide holder, and a support leg. The mounting leg is attached to the rod body. The guide holder holds the guide ring. The support leg connects the mounting leg and the guide holder. A part of the guide holder is formed of a foam portion and a reinforced resin portion. According to this configuration, since a part of the guide holder is formed of a foam portion and a reinforced resin portion, it is possible to reduce the weight of the guide holder.

In a fishing line guide of a seventh aspect according to the sixth aspect of the present disclosure, a base part of the guide holder adjacent to the support leg is formed of a foam portion and a reinforced resin portion. According to this configuration, since the base part of the guide holder is formed of a foam portion and a reinforced resin portion, it is possible to reduce the weight of the guide holder.

In a fishing rod of an eighth aspect according to the sixth or seventh aspect of the present disclosure, a top part of the guide holder away from the support leg is composed only of a reinforced resin portion. The top part of the guide holder is the distal end part of the guide frame, and thus is a portion that is easily damaged. If the top part of the guide holder is formed only of the reinforced resin portion, from among the foam portion and the reinforced resin portion, it is possible to effectively prevent damage to the top part.

In a fishing rod of a ninth aspect according to the second aspect of the present disclosure, the guide frame comprises a mounting leg, a guide holder, and a support leg. The mounting leg is attached to the rod body. The guide holder holds the guide ring. The support leg connects the mounting leg and the guide holder. The mounting leg, the guide holder, and the support leg are all formed of a foam portion and a reinforced resin portion. According to this configuration, since the mounting leg, the guide holder, and the support leg are all formed of a foam portion and a reinforced resin portion, it is possible to easily reduce the weight of the guide frame and easily prevent damage to the guide frame.

In the fishing line guide of the tenth aspect according to any one of the first to fourth aspects of the present disclosure, the foam portion has a foam layer, and the reinforced resin portion comprises a first reinforced resin layer covering a part of the foam layer on a rod tip side, and a second reinforced resin layer covering a part of the foam layer on a rod butt side.

As described above, since foam portions and reinforced resin portions are provided, weight reduction is easy, the necessary strength can be easily ensured, and damage can be easily prevented. Furthermore, impact can be absorbed by the foam portion.

### BRIEF DESCRIPTION OF THE DRAWINGS

FIG. 1 is a perspective view of a fishing line guide according to a first embodiment of the present disclosure.

FIG. 2 is a front view of the fishing line guide as viewed along the direction of a center line of a fishing rod body.

FIG. 3 is a side view of the fishing line guide.

FIG. 4 is an enlarged view of the P portion in FIG. 3.

FIG. 5 is a cross-section diagram along the A-A line in FIG. 2.

FIG. 6A is a front view showing a method for producing a guide frame of the fishing line guide.

FIG. 6B is a cross-section diagram of the guide frame.

FIG. 7 is a cross-section diagram showing a method for producing the guide frame.

FIG. 8A and FIG. 8B are cross-section diagrams showing a method for producing the guide frame.

FIG. 9A and FIG. 9B show a method for producing the guide frame, where FIG. 9A is a front view and FIG. 9B is a side view.

FIG. 10 is a front view of a fishing line guide according to a second embodiment of the present disclosure.

FIG. 11 is a cross section diagram along the B-B line in FIG. 10.

FIG. 12A and FIG. 12B show a method for producing a guide frame of the fishing line guide, where FIG. 12A is a front view and FIG. 12B is a cross-sectional view.

FIG. 13A is an enlarged view of the D portion in FIG. 12B, FIG. 13B is an enlarged view of the E portion in FIG. 12B, and FIG. 13C is an enlarged view of the F portion in FIG. 12B.

FIG. 14 is a front view of a fishing line guide according to a third embodiment of the present disclosure.

FIG. 15 is a cross section diagram along the C-C line in FIG. 14.

FIG. 16A and FIG. 16B show a method for producing a guide frame of the fishing line guide, where FIG. 16A is a front view and FIG. 16B is a cross-sectional view.

FIG. 17A is an enlarged view of the G portion in FIG. 16B, and FIG. 17B is an enlarged view of the H portion in FIG. 16B.

FIG. 18 is a cross-section diagram corresponding to the cross section along the A-A line showing a fishing line guide according to a fourth embodiment of the present disclosure.

FIG. 19 is a perspective view of a guide frame of a fishing line guide according to a fifth embodiment of the present disclosure.

FIG. 20 is a side view of the guide frame.

### DETAILED DESCRIPTION

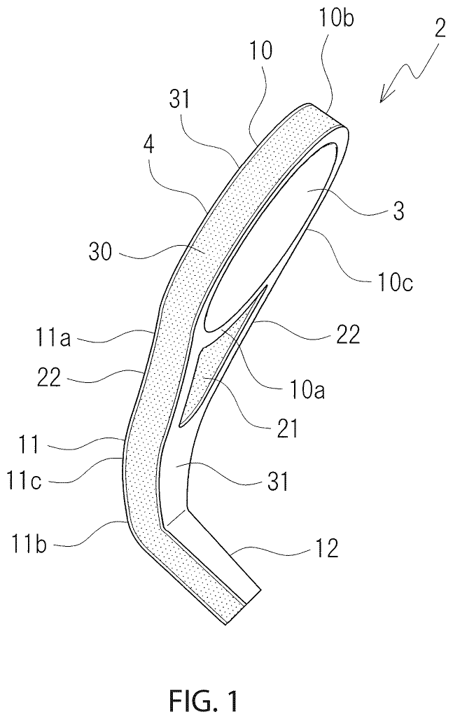

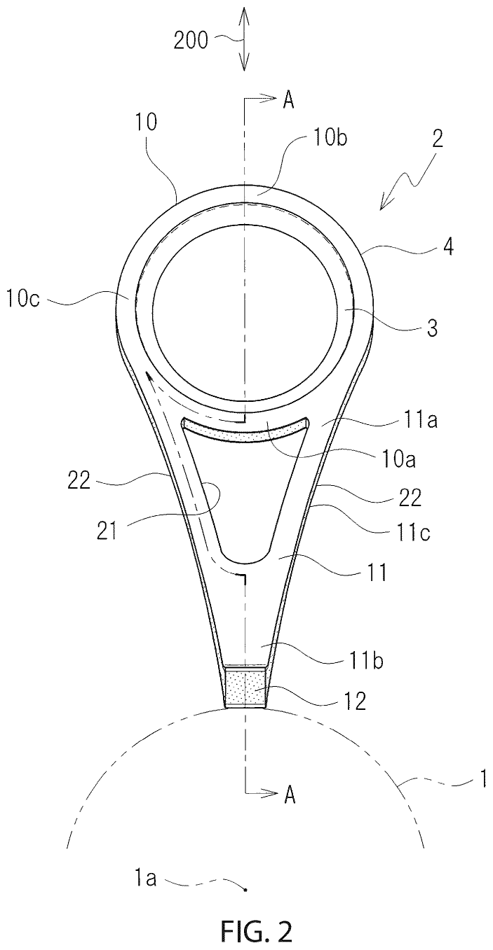

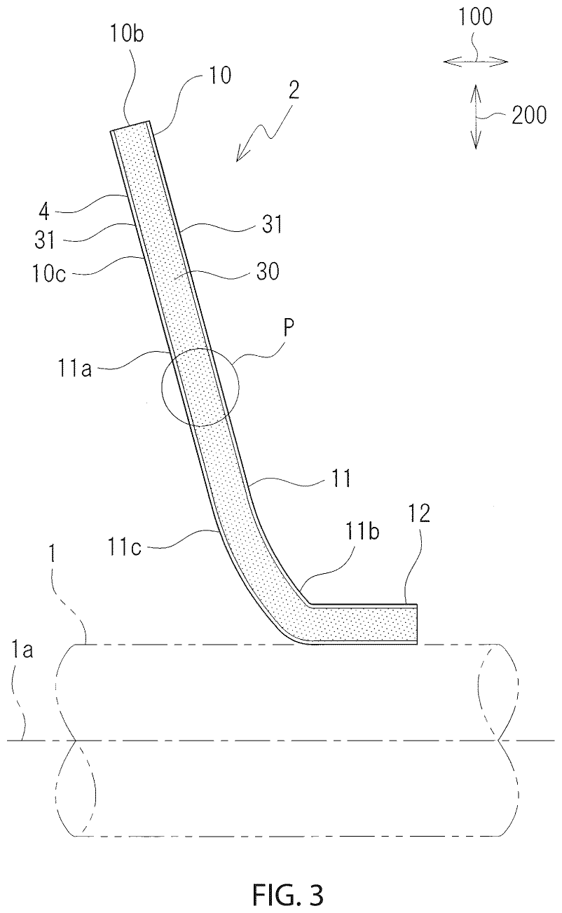

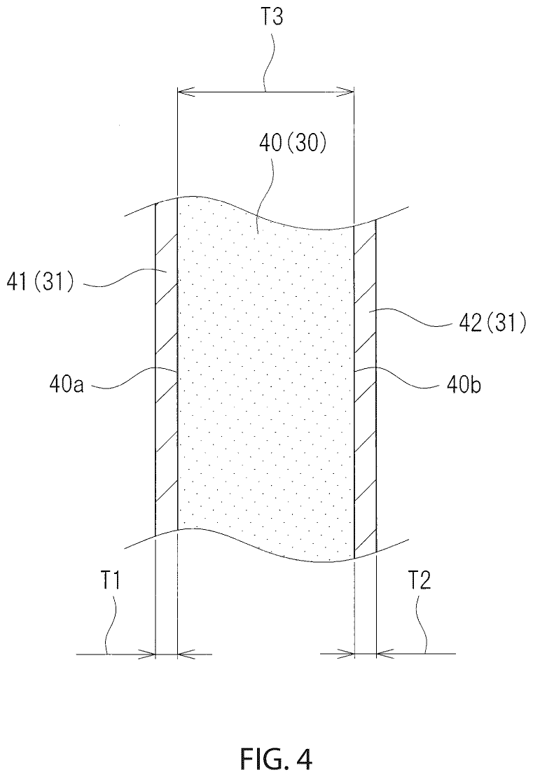

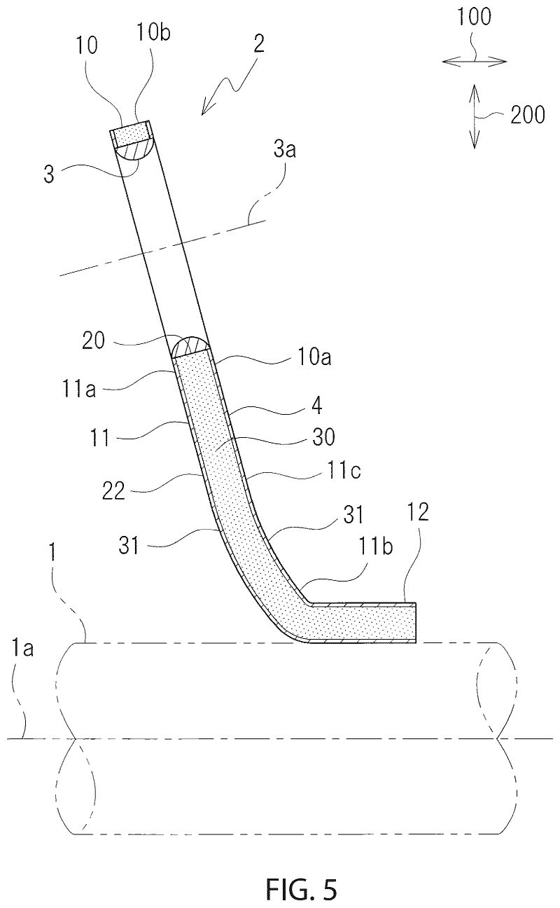

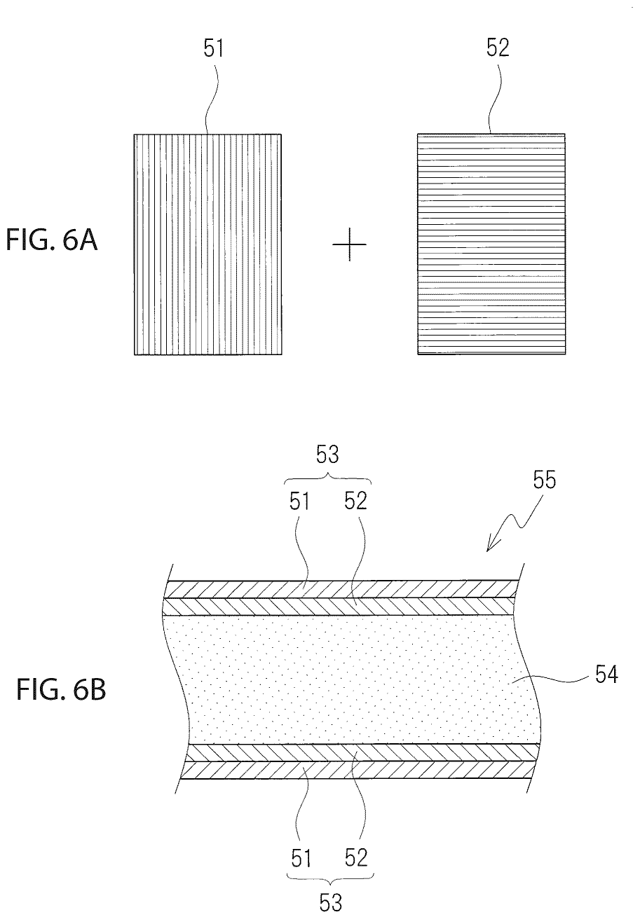

A fishing line guide according to the first embodiment of the present disclosure will be described below, with reference to the drawings. FIGS. 1 to 5 show a fishing line guide 2 according to the first embodiment, and FIGS. 6A to 9B show a method for producing the fishing line guide 2. The fishing line guide 2 is attached to various fishing rods to which a fishing reel can be attached. The fishing line guide 2 is a so-called external guide and is attached to the outer circumferential surface of a rod body 1 in either a movable or immovable manner. The reel is, for example, a spinning reel or a dual-bearing reel. In a fishing rod to which a spinning reel is attached, the fishing line guide 2 is located on the lower side of the rod body 1 during use, and in a fishing rod to which a dual-bearing reel is attached, the fishing line guide 2 is located on the upper side of the rod body 1 during use. The fishing line guide 2 according to the present embodiment is suitable for a fishing rod to which a spinning reel is attached. However, for convenience of explanation, the fishing line guide 2 is shown in a state of being located on the upper side of the rod body 1. The rod body 1 is a so-called blank, and is made of fiber-reinforced resin. The rod body 1 is cylindrical and therefore can be hollow or solid. The rod body 1 is formed of one or more rod bodies.

The fishing line guide 2 comprises a guide ring 3 and a guide frame 4. The guide ring 3 can guide a fishing line. The fishing line passes through the radially inner side of the guide ring 3 and slides against the inner circumferential surface of the guide ring 3. The fishing line is guided by the inner circumferential surface of the guide ring 3. The guide ring 3 can be made of various materials such as SiC. The orientation of a ring center line 3a of the guide ring 3 can be parallel to the orientation (axial direction 100) of a rod center line 1a of the rod body 1, but is inclined toward the rod tip side with respect to the axial direction 100 of the rod body 1 in the present embodiment. The fishing line guide 2 can be configured without the guide ring 3, and the guide frame 4 can directly guide the fishing line.

The guide frame 4 holds the guide ring 3 and is attached to the rod body 1. The guide frame 4 is plate-shaped and comprises a guide holder 10 that holds the guide ring 3, a mounting leg 12 that is attached to the rod body 1, and a support leg 11 that connects the guide holder 10 and the mounting leg 12. The guide holder 10 has a ring mounting opening 20. The ring mounting opening 20 penetrates the guide holder 10. The guide ring 3 is inserted into the ring mounting opening 20 and the guide ring 3 is thereby mounted on the guide holder 10. That is, the guide ring 3 is mounted onto the inner circumferential surface of the guide holder 10. The guide ring 3 is preferably adhesively fixed to the guide holder 10. The guide holder 10 and the guide ring 3 are coaxial, and the center line of the guide holder 10 preferably coincides with the ring center line 3a of the guide ring 3. Accordingly, the guide holder 10 is inclined toward the rod tip side. The guide holder 10 has a circular shape. The guide holder 10 has a base part 10a that is adjacent to the support leg 11, a top part 10b that is far from the support leg 11, and a middle part 10c that is located between the base part 10a and the top part 10b and connects the base part 10a and the top part 10b. The guide holder 10 can be classified into the base part 10a, the top part 10b, and the middle part 10c. The support leg 11 is connected to the base part 10a of the guide holder 10.

The support leg 11 has a leg tip 11a that is close to the guide holder 10, a base part 11b that is adjacent to the mounting leg 12, and a leg intermediate part 11c that is located between the leg tip 11a and the base part 11b and connects the leg tip 11a and the base part 11b. The leg tip 11a is connected to the guide holder 10 and the base part 11b is connected to the mounting leg 12. The support leg 11 is formed so as to gradually widen from the mounting leg 12 toward the guide holder 10. The support leg 11 has a through-hole 21. The through-hole 21 is adjacent to the guide holder 10. The through-hole 21 has an inverted triangular shape with the mounting leg 12 side serving as the apex. The through-hole 21 includes the leg tip 11a to the leg intermediate part 11c. As a result of the through-hole 21 being formed in the support leg 11, the support leg 11 has one pair of left and right branched leg portions 22 branching to the left and right. The branched leg portions 22 are formed from the leg tip 11a to the leg intermediate part 11c. Each of the pair of left and right branched leg portions 22 is connected to the guide holder 10, specifically, to the base part 10a of the guide holder 10. The locations where the pair of left and right branched leg portions 22 connect to the guide holder 10 are spaced apart from each other in the circumferential direction of the guide holder 10.

In the present embodiment, the mounting leg 12 is fixed to the outer circumferential surface of the rod body 1. The mounting leg 12 is fixed to the rod body 1 by a winding thread (not shown), for example. Preferably, an adhesive is applied to the surface of the winding thread that has been wound. The mounting leg 12 extends from the base part 11b of the support leg 11 toward the rod butt side. The base part 11b of the support leg 11 is connected to the distal end of the mounting leg 12 on the rod tip side. The support leg 11 is bent relative to the mounting leg 12 in a radial direction 200 of the rod body 1. The mounting leg 12 is aligned along the axial direction 100 of the rod body 1.

In the present embodiment, the guide frame 4 is entirely formed of a foam portion 30 and a reinforced resin portion 31. The foam portion 30 is made of foamed resin. The reinforced resin portion 31 is made of fiber-reinforced resin. The foam portion 30 has a smaller specific gravity than the reinforced resin portion 31. An example of the reinforcing fiber is carbon fiber. The foam portion 30 has a foam layer 40. The reinforced resin portion 31 has a first reinforced resin layer 41 and a second reinforced resin layer 42. The guide frame 4 has a multilayer structure, being formed of a total of three layers. That is, the guide frame 4 is formed of the foam layer 40, the first reinforced resin layer 41, and the second reinforced resin layer 42. The thickness of the guide frame 4 can be constant.

The foam layer 40 is an intermediate layer of the guide frame 4. The foam layer 40 occupies half or more of the total thickness of the guide frame 4. As described below, the foam layer 40 includes a foam sheet 54. The first reinforced resin layer 41 is superposed on the rod tip side of the foam layer 40. The first reinforced resin layer 41 covers a part of a first foam surface 40a of the foam layer 40 on the rod tip side. The first foam surface 40a is the surface facing the rod tip side. In the present embodiment, the first reinforced resin layer 41 covers the entire first foam surface 40a of the foam layer 40. The first reinforced resin layer 41 is a first protective layer that protects the first foam surface 40a of the foam layer 40. The second reinforced resin layer 42 is superposed on the rod butt side of the foam layer 40. The second reinforced resin layer 42 covers a part of a second foam surface 40b of the foam layer 40 on the rod butt side. The second foam surface 40b is a surface on the opposite side of the first foam surface 40a. The second foam surface 40b faces the rod butt side. In the present embodiment, the second reinforced resin layer 42 covers the entire second foam surface 40b on the rod butt side of the foam layer 40. The second reinforced resin layer 42 is a second protective layer that protects the second foam surface 40b of the foam layer 40. As described further below, the first reinforced resin layer 41 and the second reinforced resin layer 42 are formed from pre-preg (pre-impregnated).

The first reinforced resin layer 41 and the second reinforced resin layer 42 sandwich the foam layer 40 in the axial direction 100 of the rod body 1. The first reinforced resin layer 41 is a surface layer on the rod tip side of the guide frame 4 and the second reinforced resin layer 42 is the surface layer on the rod butt side of the guide frame 4. In this manner, the guide frame 4 has a three-layer structure comprising a total of the following three layers: the foam layer 40, the first reinforced resin layer 41, and the second reinforced resin layer 42. A separate layer can be provided on the rod tip side (outer side) of the first reinforced resin layer 41, and a separate layer can be provided on the rod butt side (outer side) of the second reinforced resin layer 42. The first reinforced resin layer 41 has a first thickness T1, the second reinforced resin layer 42 has a second thickness T2, and the foam layer 40 has a third thickness T3. The first thickness T1 is the same as the second thickness T2, but can be different. The third thickness T3 is greater than the first thickness T1 and the second thickness T2.

A first frame surface of the guide frame 4 on the rod tip side is formed of the first reinforced resin layer 41. The foam layer 40 is not exposed on the first frame surface. A second frame surface of the guide frame 4 on the rod butt side is formed of the second reinforced resin layer 42. The foam layer 40 is not exposed on the second frame surface. On the other hand, the foam layer 40 is exposed without being covered by the first reinforced resin layer 41 or the second reinforced resin layer 42 on the peripheral side surface of the guide frame 4, on the inner circumferential surface (wall surface of the ring mounting opening 20) of the guide holder 10, and on the inner circumferential surface (wall surface of the through-hole 21) of the support leg 11. That is, the foam layer 40 (foam portion 30) is exposed on the end surface of the guide frame 4 without being covered by the reinforced resin portion 31. A coating layer can be provided by applying paint, or the like, on the peripheral side surface of the guide frame 4, the inner circumferential surface of the guide holder 10, and the inner circumferential surface of the support leg 11.

FIGS. 6A to 9B show a method for producing the guide frame 4. Any given number of pre-preg (pre-impregnated) can constitute the first reinforced resin layer 41 and the second reinforced resin layer 42, but in the present embodiment, the reinforced resin layers are formed from two pre-preg (pre-impregnated), as an example. The first reinforced resin layer 41 and the second reinforced resin layer 42 can have the same or different specifications, but have the same specifications in the present embodiment. The two pre-preg (pre-impregnated) that respectively constitute the first reinforced resin layer 41 and the second reinforced resin layer 42 are formed of a first prepreg 51 in which reinforcing fibers are aligned in a first direction, and a second prepreg 52 in which reinforcing fibers are aligned in a second direction that is perpendicular to the first direction, as shown in Figure A6A. The first prepreg 51 and the second prepreg 52 are preferably laminated in advance. It is preferable to form, in advance, a laminated prepreg 53 obtained by laminating the first prepreg 51 and the second prepreg 52

The foam layer 40 includes the foam sheet 54. As shown in Figure B6B, the laminated prepreg 53 is laminated on both surfaces of the foam sheet 54 to form a composite sheet 55. The composite sheet 55 is preferably made in the form of a strip. Either the first prepreg 51 or the second prepreg 52 can be exposed on the surface of the composite sheet 55, but it is preferable that the first prepreg 51 is exposed on both sides of the composite sheet 55, or that the second prepreg 52 is exposed on both sides of the composite sheet 55. In Figure B6B, an example is shown in which the first prepreg 51 is exposed on both sides of the composite sheet 55. The thickness of the composite sheet 55 is smaller than the thickness (total thickness) of the guide frame 4.

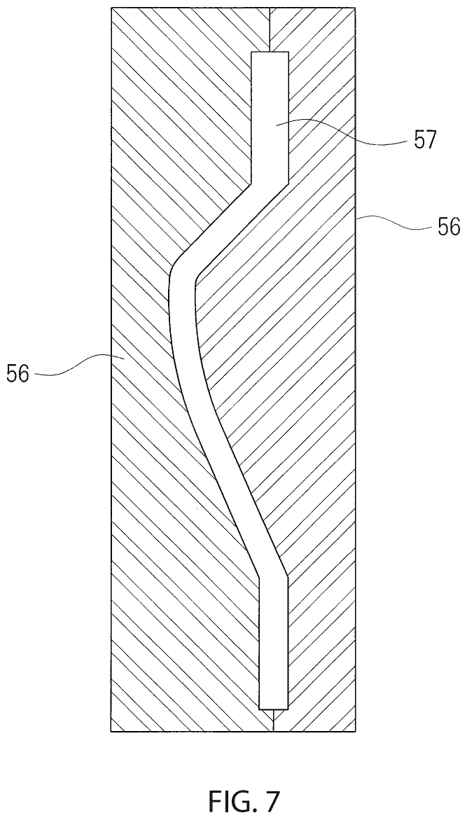

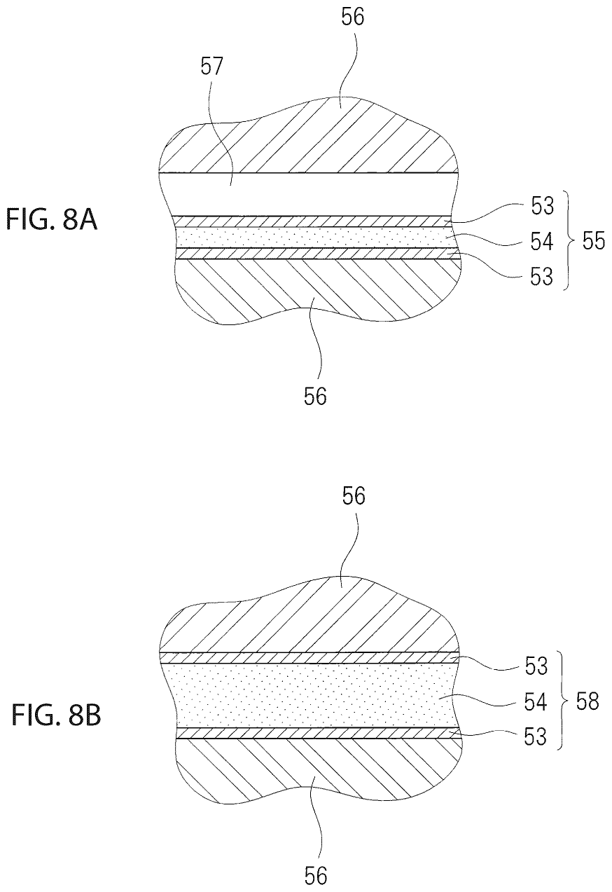

FIG. 7 shows a cross section of a metal mold 56. The composite sheet 55 is placed into a cavity 57 of the metal mold 56. As shown in FIG. 8A, the composite sheet 55 is placed along one of the metal mold 56 sides of the cavity 57. In the cavity 57, the composite sheet 55 is placed eccentrically on one of the metal mold 56 sides. The composite sheet 55 is thinner than the thickness of the cavity 57. Therefore, even when the composite sheet 55 is placed in the cavity 57, a space remains in the cavity 57. The composite sheet 55 is then heated in the metal mold 56. As shown in FIG. 8B, the foam sheet 54 of the composite sheet 55 undergoes secondary foaming and expands, and the laminated prepreg 53 hardens. The force with which this foam sheet 54 expands can be used to mold the composite sheet 55 into the shape of the guide frame 4.

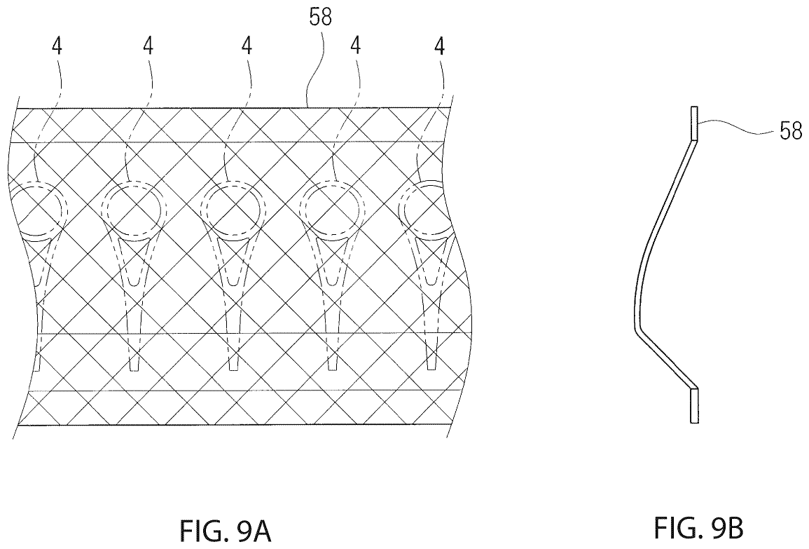

A molded sheet 58 obtained by molding the composite sheet 55 into a prescribed shape is shown in FIGS. 9A and 9B. The crosshatching in FIG. 9A indicates the part of the total width of the molded sheet 58 where the foam sheet 54 (foam portion 30) is provided. In the present embodiment, the foam sheet 54 is provided across the entire width of the molded sheet 58, and thus crosshatching is applied to the entire molded sheet 58. A plurality of the guide frames 4 can be produced from this molded sheet 58. The shape of the guide frame 4 is indicated by chain double-dashed lines in FIG. 9A. The composite sheet 55 is in the shape of a strip that is long along a prescribed direction. The guide frames 4 are virtually illustrated such that the guide frames 4 will be aligned along a prescribed direction (longitudinal direction) of this strip-shaped composite sheet 55. A plurality of the guide frames 4 can be formed by cutting or punching this composite sheet 55 in the thickness direction, for example. The ring mounting opening 20 and the through-hole 21 can also be formed at the time of said punching process, or the like.

As described above, the fishing line guide according to the present embodiment comprises the guide frame 4 comprising the foam portion 30 and the reinforced resin portion 31. Therefore, the fishing line guide 2 can be easily reduced in weight, compared to the guide frame 4 composed only of the reinforced resin portion 31. Moreover, since the reinforced resin portion 31 covers the foam portion 30, the foam portion 30 is protected by the reinforced resin portion 31. Therefore, it is possible to effectively prevent damages to the foam portion 30. In addition, since impact can be absorbed by the foam portion 30, it is possible to make the reinforced resin portion 31 thin and easily achieve both weight reduction and strength assurance of the guide frame 4.

In particular, since the guide frame 4 has a three-layer structure comprising the foam layer 40, which is the foam portion 30, and the first reinforced resin layer 41 and the second reinforced resin layer 42, which are the reinforced resin portions 31, the guide frame 4 can be easily manufactured. In addition, since the first reinforced resin layer 41 and the second reinforced resin layer 42 entirely cover and protect both sides of the foam layer 40, it is possible to more reliably prevent damage to the foam layer 40.

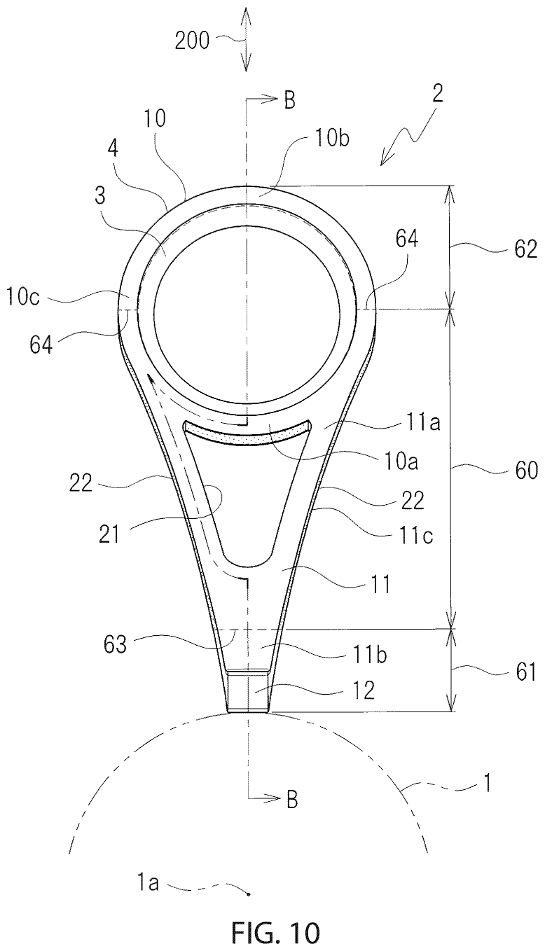

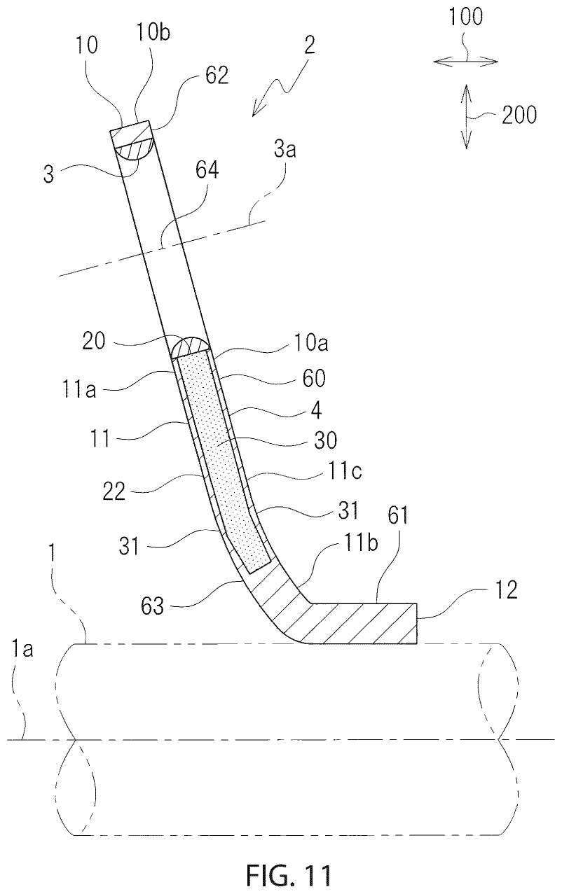

FIGS. 10 to 13B shows a fishing line guide 2 according to a second embodiment. In the first embodiment described above, the entire guide frame 4 has a three-layer structure comprising the foam layer 40, the first reinforced resin layer 41, and the second reinforced resin layer 42. That is, the entire guide frame 4 is formed of the foam portion 30 and the reinforced resin portion 31. On the other hand, in the present embodiment, only a part of the guide frame 4 has a three-layer structure, that is, a mixed configuration portion 60 formed of the foam portion 30 and the reinforced resin portion 31. The remaining part of the guide frame 4 other than the mixed configuration portion 60 lacks the foam portion 30, forming a single configuration portion composed only of the reinforced resin portion 31.

Specifically, the guide frame 4 is formed of a first reinforced resin portion 61, the mixed configuration portion 60, and a second reinforced resin portion 62. The first reinforced resin portion 61, the mixed configuration portion 60, and the second reinforced resin portion 62 are aligned along the radial direction 200 of the rod body 1. The first reinforced resin portion 61 is provided on the mounting leg 12 side, and the second reinforced resin portion 62 is provided away from the first reinforced resin portion 61 in the radial direction 200 of the rod body 1. The mixed configuration portion 60 is provided between the first reinforced resin portion 61 and the second reinforced resin portion 62 and connects the first reinforced resin portion 61 and the second reinforced resin portion 62.

The mounting leg 12 is entirely formed of the first reinforced resin portion 61. The support leg 11 is formed of the first reinforced resin portion 61 and the mixed configuration portion 60. The part of the support leg 11 adjacent to the mounting leg 12 is formed of the first reinforced resin portion 61, and the part of the support leg 11 adjacent to the guide holder 10, that is, the remaining portion that is not the first reinforced resin portion 61, is formed of the mixed configuration portion 60. The base part 11b of the support leg 11 is formed of the first reinforced resin portion 61. The leg intermediate part 11c and the leg tip 11a of the support leg 11 are both formed of the mixed configuration portion 60.

The guide holder 10 is formed of the mixed configuration portion 60 and the second reinforced resin portion 62. The part of the guide holder 10 adjacent to the support leg 11 is formed of the mixed configuration portion 60, and the part of the guide holder 10 away from the support leg 11, that is, the remaining portion that is not the mixed configuration portion 60, is formed of the second reinforced resin portion 62. The base part 10a of the guide holder 10 is formed of the mixed configuration portion 60. The top part 10b of the guide holder 10 is formed of the second reinforced resin portion 62. The middle part 10c of the guide holder 10 is formed of the mixed configuration portion 60 and the second reinforced resin portion 62.

The position of a first structure boundary portion 63 between the first reinforced resin portion 61 and the mixed configuration portion 60 can vary. However, the first structure boundary portion 63 is preferably provided on the support leg 11. Accordingly, the first reinforced resin portion 61 preferably extends beyond the mounting leg 12 by a prescribed length to the support leg 11, so that it is possible to easily ensure the strength at the boundary between the mounting leg 12 and the support leg 11. From the viewpoint of weight reduction, the first structure boundary portion 63 is preferably provided further on the mounting leg 12 side with respect to the center of the support leg 11 in the radial direction 200 of the rod body 1.

The position of the second structure boundary portion 64 between the mixed configuration portion 60 and the second reinforced resin portion 62 can also vary. However, the second structure boundary portion 64 is preferably provided in the guide holder 10. In the present embodiment, the second structure boundary portion 64 is provided in the center of the guide holder 10 in the circumferential direction. Accordingly, the guide holder 10 can have two halves, the half of the guide holder 10 that is farther from the rod body 1 is formed of the second reinforced resin portion 62, and the half of the guide holder 10 that is closer to the rod body 1 is formed of the mixed configuration portion 60. Note that weight reduction is accomplished by moving the position of the second structure boundary portion 64 away from the rod body 1. If the position of the second structure boundary portion 64 is brought closer to the rod body 1, the rigidity of the guide frame 4 can be increased, particularly the rigidity of the guide holder 10.

In the first embodiment described above, the foam sheet 54 is disposed on the entire composite sheet 55, but in the present embodiment, the foam sheet 54 is disposed on only a part of the composite sheet 55. The foam sheet 54 is provided, of the total width of the composite sheet 55, only to the central portion constituting the mixed configuration portion 60, while the other portions are made of only the prepreg without the foam sheet 54, and the thickness is adjusted by increasing the number of prepreg layers.

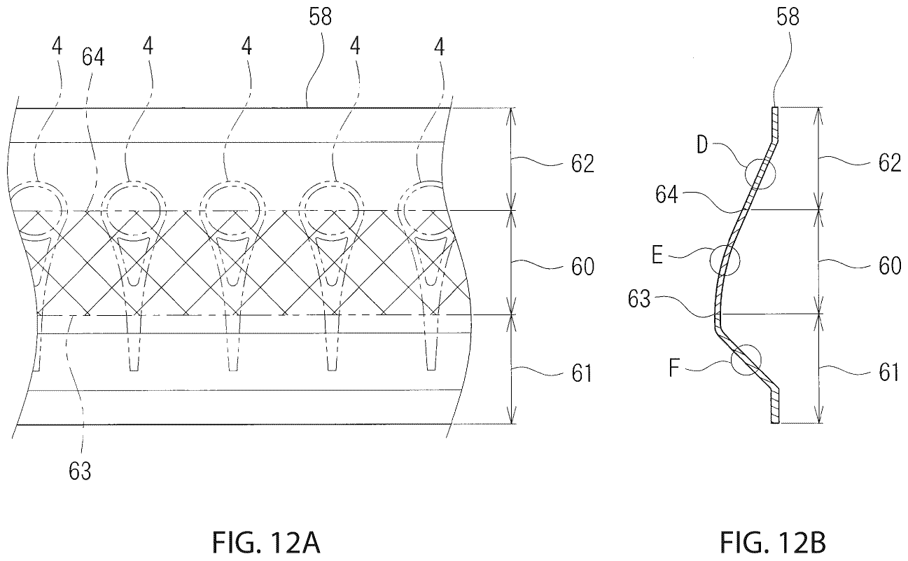

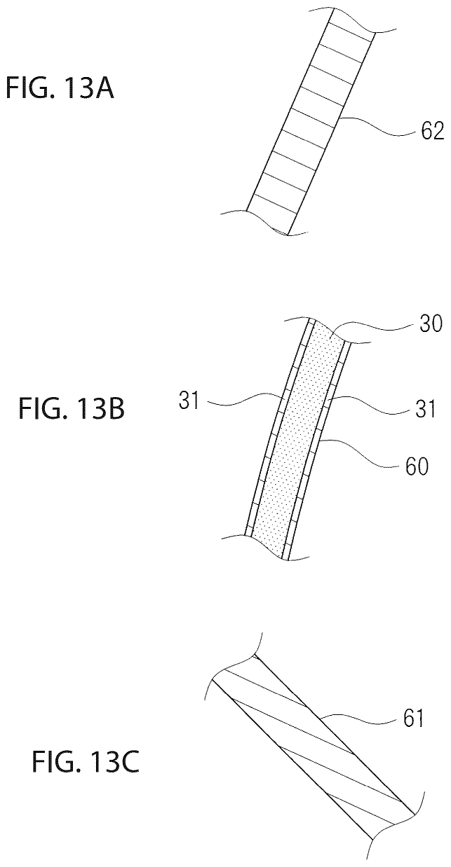

FIGS. 12A and 12B show the molded sheet 58, and FIGS. 13A, 13B and 13C show cross-sectional views of each portion. The crosshatching in FIG. 12A indicates the part of the total width of the molded sheet 58 where the foam sheet 54 is provided. The portion where the foam sheet 54 is provided is the mixed configuration portion 60, and the portion where the foam sheet 54 is not provided is the first reinforced resin portion 61 and the second reinforced resin portion 62. In this manner, it is possible to adjust the width of the foam sheet 54 to easily set the region of the mixed configuration portion 60. In addition, it is possible to adjust the position of the foam sheet 54 on the composite sheet 55 to easily set the position of the mixed configuration portion 60 on the guide frame 4.

As described above, in the present embodiment, since the first reinforced resin portion 61 extends to the support leg 11, it is possible to ensure the strength at the boundary between the support leg 11 and the mounting leg 12, that is, at the bent portion. In addition, the top part 10b of the guide holder 10 is formed of the second reinforced resin portion 62. The top part 10b of the guide holder 10 is the part of the guide frame 4 that is farthest from the rod body 1 and that is prone to damage. By forming the top part 10b of the guide holder 10 from the second reinforced resin portion 62, the strength of the area near the top part 10b of the guide holder 10 can be increased, and damage to the top part 10b can be effectively suppressed.

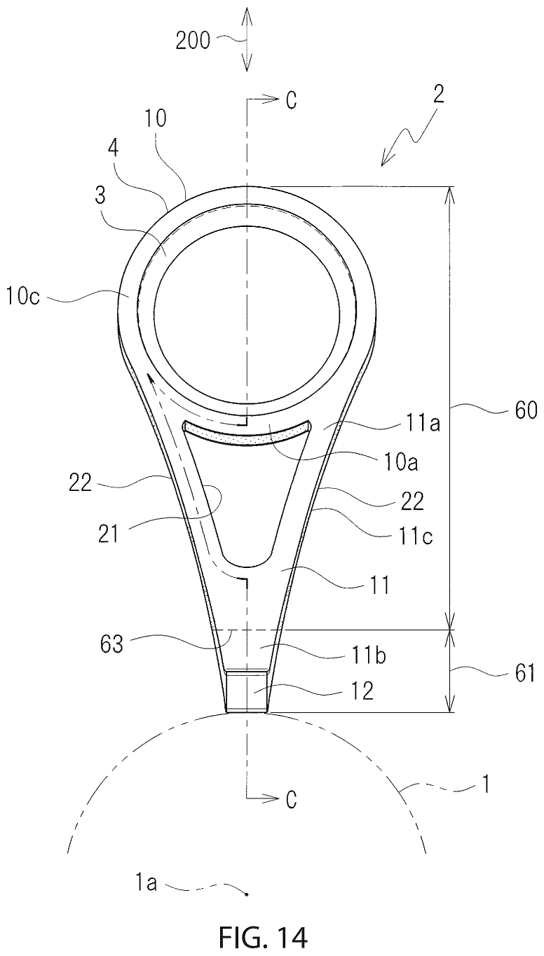

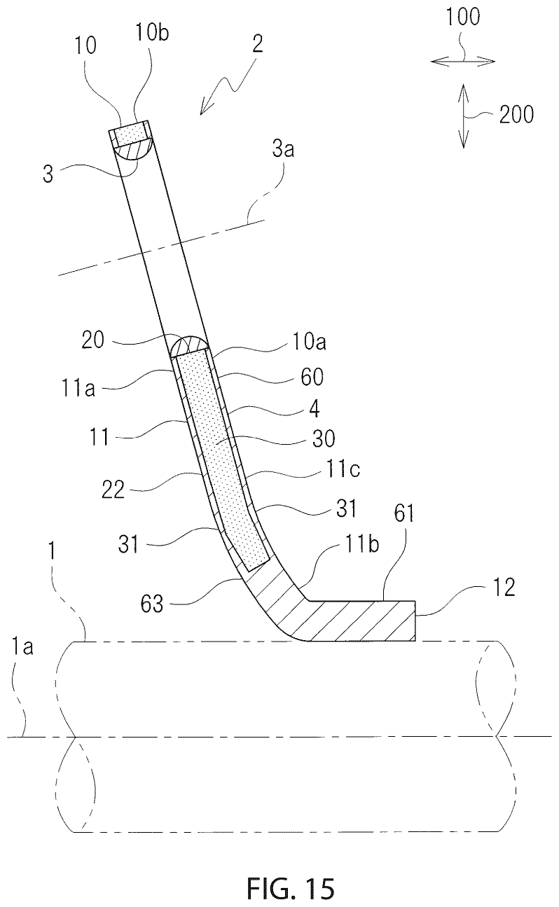

FIGS. 14 to 17B show a fishing line guide 2 according to a third embodiment. In the second embodiment described above, the guide frame 4 is formed of the first reinforced resin portion 61, the mixed configuration portion 60, and the second reinforced resin portion 62, but in the present embodiment, the guide frame 4 is formed of the first reinforced resin portion 61 and the mixed configuration portion 60. The location of the first structure boundary portion 63 is the same as that in the second embodiment. The point that the entire guide holder 10 is formed of the mixed configuration portion 60 is the difference from the second embodiment. By forming the entire guide holder 10 from the mixed configuration portion 60, the weight can be further reduced.

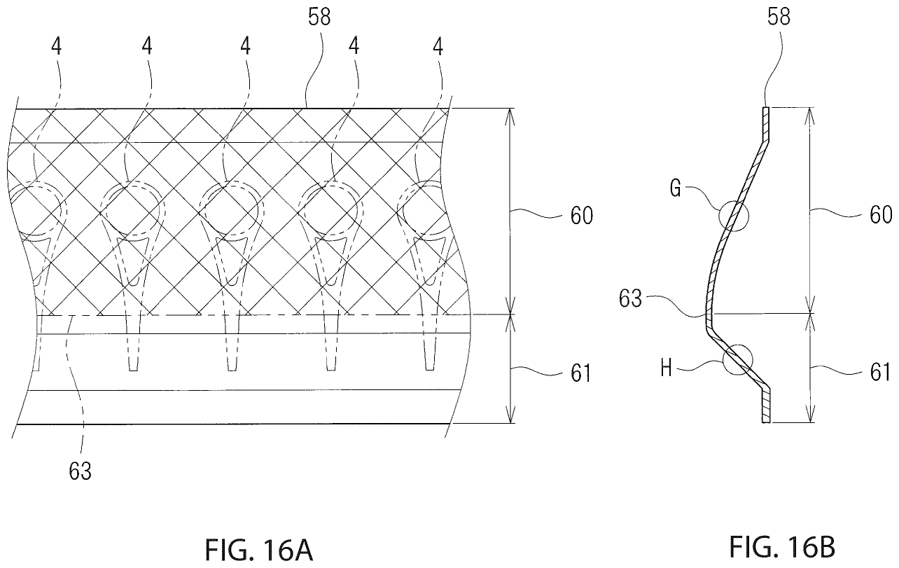

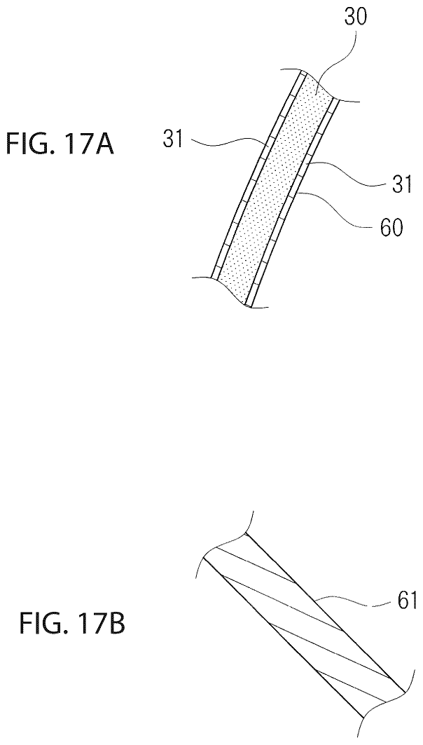

In the second embodiment described above, the foam sheet 54 is disposed only on the central part of the total width of the composite sheet 55, but in the present embodiment, the foam sheet 54 is disposed on all portions excluding the portion on the mounting leg 12 side. FIGS. 16A and 16B show the molded sheet 58, and FIGS. 17A and 17B show cross-sectional views of each portion. The crosshatching in FIG. 16A indicates the part of the total width of the molded sheet 58 where the foam sheet 54 is provided. The portion where the foam sheet 54 is provided is the mixed configuration portion 60, and the portion where the foam sheet 54 is not provided is the first reinforced resin portion 61. Both weight reduction and high rigidity can be achieved with the mixed configuration portion 60 and the first reinforced resin portion 61.

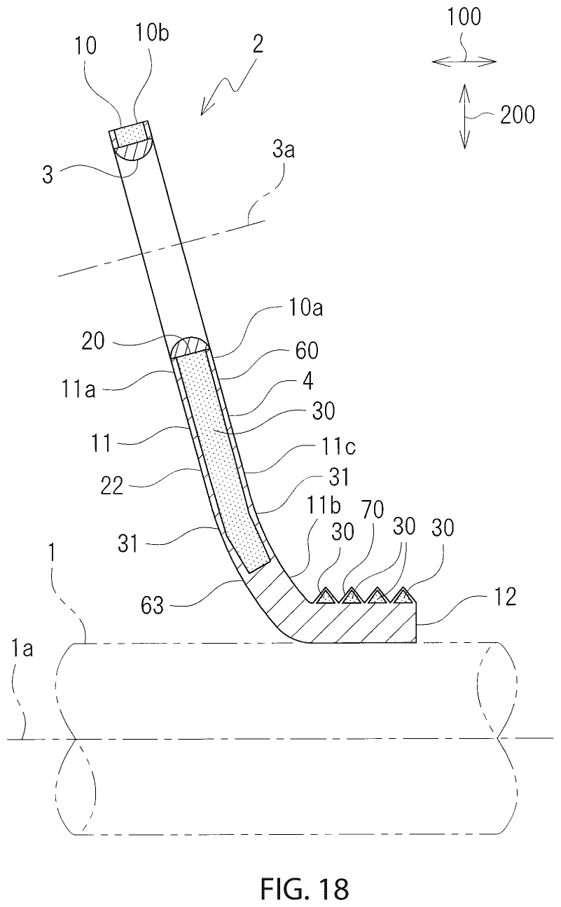

FIG. 18 shows a fishing line guide 2 according to a fourth embodiment. The only difference from the third embodiment described above is the configuration of the mounting leg 12. In the present embodiment, an uneven portion 70 is disposed on a surface of the mounting leg 12 opposite to the surface facing the rod body 1. By providing the uneven portion 70, the attachment to the rod body 1 with the winding thread can be made even stronger. The foam portion 30 is provided inside the uneven portion 70. By providing the foam portion 30, the uneven portion 70 can be formed at the time of molding.

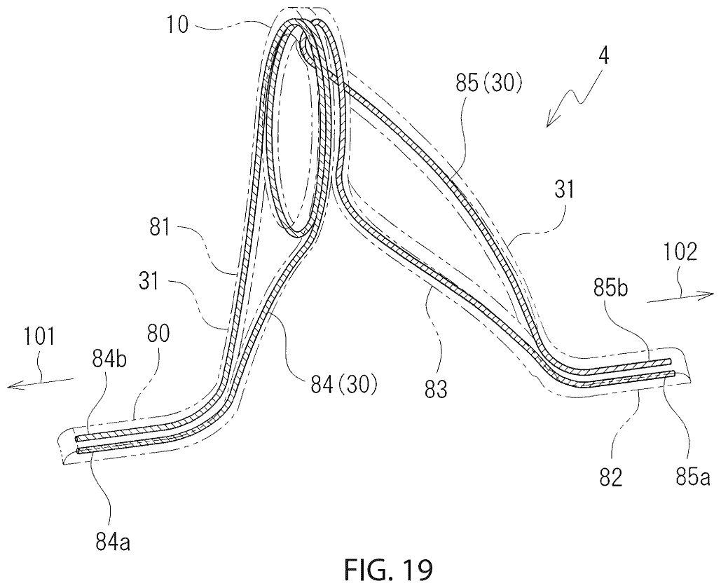

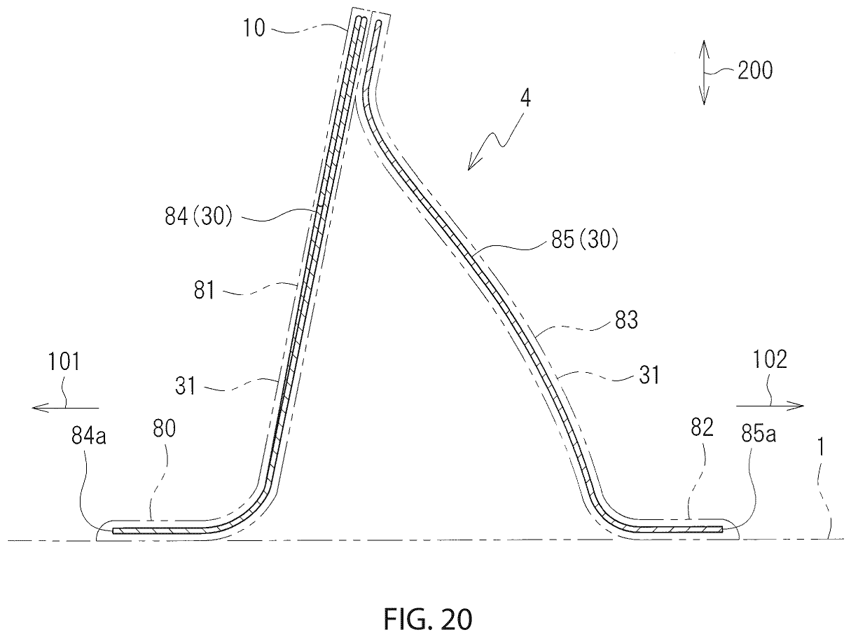

FIGS. 19 and 20 show a guide frame 4 of a fishing line guide 2 according to a fifth embodiment. The guide frame 4 of the present embodiment has a two-legged configuration. That is, the guide frame 4 comprises the guide holder 10, a first mounting leg 80 provided toward a first direction 101 of the axial direction 100 of the rod body 1 with respect to the guide holder 10, a first support leg 81 that connects the guide holder 10 and the first mounting leg 80, a second mounting leg 82 provided toward a second direction 102 of the axial direction 100 of the rod body 1 with respect to the guide holder 10, and a second support leg 83 that connects the guide holder 10 and the second mounting leg 82. The first direction 101 is, for example, the rod tip side, and the second direction 102 is, for example, the rod butt side, but the directions can be reversed. The first mounting leg 80 extends from the first support leg 81 in the first direction 101, and the second mounting leg 82 extends from the second support leg 83 in the second direction 102, opposite to the direction in which the first mounting leg 80 extends. Each of the first support leg 81 and the second support leg 83 branches to the left and right.

The guide frame 4 comprises a first string-like foam portion 84 and a second string-like foam portion 85, which are string-like in shape. The first string-like foam portion 84 is formed of one foam cord. A first string end 84a and a second string end 84b of the first string-like foam portion 84 are arranged next to each other. The first string end 84a and the second string end 84b face the first direction 101. The first string end 84a and the second string end 84b are positioned at the end of the first mounting leg 80 in the first direction 101. The first string-like foam portion 84 extends from the first string end 84a in the second direction 102 along the first mounting leg 80, then extends to the first support leg 81 and spirals around the guide holder 10 by one and a half revolutions, returns back to the first support leg 81, heads toward the first mounting leg 80, returns to the first mounting leg 80, and extends in the first direction 101 along the first mounting leg 80 to reach the second string end 84b.

The second string-like foam portion 85 is a separate body from the first string-like foam portion 84, and is formed of one foam cord. A third string end 85a and a fourth string end 85b of the second string-like foam portion 85 are arranged next to each other. The third string end 85a and the fourth string end 85b face the second direction 102. The third string end 85a and the fourth string end 85b are positioned at the end of the second mounting leg 82 in the second direction 102. The second string-like foam portion 85 extends from the third string end 85a in the first direction 101 along the second mounting leg 82, then extends to the second support leg 83 and extends in the circumferential direction around half of the circumference of the guide holder 10, returns back to the second support leg 83, heads toward the second mounting leg 82, returns to the second mounting leg 82, and extends in the second direction 102 along the second mounting leg 82 to reach the fourth string end 85b.

The first string-like foam portion 84 and the second string-like foam portion 85 are each formed of a foam cord. Two foam cords are placed in the metal mold 56, and the foam cords are subjected to secondary foaming in the metal mold 56, thereby forming the first string-like foam portion 84 and the second string-like foam portion 85. By using foam cords in this manner, it is possible to form the first string-like foam portion 84 and the second string-like foam portion 85, which are foam portions 30, and to adapt to guide frames 4 having various shapes.

The reinforced resin portion 31 encases the first string-like foam portion 84 and the second string-like foam portion 85. In the figure, the reinforced resin portion 31 is indicated by the chain double-dashed line. The reinforced resin portion 31 is located on the outer sides of the first string-like foam portion 84 and the second string-like foam portion 85. The first string-like foam portion 84 and the second string-like foam portion 85 are entirely covered by the reinforced resin portion 31. The reinforced resin portion 31 includes synthetic resin, in which short fibers having a length of 1 mm or less are mixed. The short fibers are, for example, carbon fibers. The length of the short fibers is preferably 0.5 mm or less. Synthetic resin mixed with short fibers can be injected into the metal mold 56 in which two foam cords are placed to integrally form the guide frame 4 by injection molding.

The guide frame 4 can be formed by separately molding a first portion having the first string-like foam portion 84 and a second portion having the second string-like foam portion 85, and, after the molding of the two parts, joining the two parts into one integral body.

What is claimed is:

1. A fishing line guide mountable to a fishing rod body to guide a fishing line, the fishing line guide comprising:
a foam portion including a foamed resin; and
a reinforced resin portion including a fiber-reinforced resin and covering a part of the foam portion.

2. The fishing line guide according to claim 1, further comprising
a guide ring configured to guide the fishing line, and
a guide frame holding the guide ring and being attached to the rod body,
a part of the guide frame including the foam portion and the reinforced resin portion.

3. The fishing line guide according to claim 2, wherein
the guide frame comprises
a mounting leg mountable to the rod body,
a guide holder holding the guide ring, and
a support leg connecting the mounting leg and the guide holder, and
a part of the support leg including the foam portion and the reinforced resin portion.

4. The fishing line guide according to claim 3, wherein
the support leg includes a leg tip adjacent to the guide holder, the leg tip includes the foam portion and the reinforced resin portion.

5. The fishing line guide according to claim 3, wherein
the support leg includes a base part adjacent to the mounting leg, the base part includes the reinforced resin portion.

6. The fishing line guide according to claim 2, wherein
the guide frame comprises
a mounting leg mountable to the rod body,
a guide holder holding the guide ring, and
a support leg connecting the mounting leg and the guide holder, and
a part of the guide holder formed of the foam portion and the reinforced resin portion.

7. The fishing line guide according to claim 6, wherein
the guide holder includes a base part adjacent to the support leg, the base part includes the foam portion and the reinforced resin portion.

8. The fishing line guide according to claim 6, wherein
the guide holder includes a top portion away from the support leg, the top portion includes the reinforced resin portion.

9. The fishing line guide according to claim 2, wherein
the guide frame comprises
a mounting leg mountable to the rod body,
a guide holder holding the guide ring, and
a support leg connecting the mounting leg and the guide holder, and
the mounting leg, the guide holder, and the support leg include the foam portion and the reinforced resin portion.

10. The fishing line guide according to claim 1, wherein
the foam portion has a foam layer, and
the reinforced resin portion comprises
a first reinforced resin layer covering the foam layer on a rod tip side, and
a second reinforced resin layer covering the foam layer on a rod butt side.
